(19) United States
(12) Patent Application Publication
(10) Pub. No.: US 2026/0169849 A1
(43) Pub. Date: Jun. 18, 2026

(54) DIAGNOSTICS FAULT AND PART SCREENING FAILURE ANALYZER

(71) Applicants: Advanced Micro Devices, Inc., Santa Clara, CA (US); ATI Technologies ULC, Thornhill (CA)

(72) Inventors: Sommayeh ASGARI, Markham (CA); Jonathan MILLER, Markham (CA); Edward CASAPAO, Austin, TX (US); Mark DIVALERIO, Austin, TX (US); Nadia ESMAIELI KHATIR, Markham (CA); Mohammad Hamed MOUSAZADEH, Markham (CA)

(21) Appl. No.: 18/981,117

(22) Filed: Dec. 13, 2024

(51) Int. Cl. G06F 11/07

(52) U.S. Cl. CPC G06F 11/079; G06F 11/0709; G06F 11/0766; G06F 11/0793

(57) ABSTRACT

Embodiments herein relate to streamlining the analysis process using a data processor and an LLM. The LLM receives test case results from a diagnostics software tool indicating a fault in the hardware or software of a computing system. The LLM uses data from databases containing historical system data as well as debugging data to identify the issue and provide the most probable cause of the issue. The LLM can analyze the data presented, and determine a ranking of the most probable cause to least probable cause of the detected fault. The LLM can provide this information to the user, as well as potential solution recommendations. The fault analyzer system can validate the solution recommendation from the LLM and update the LLM's parameters accordingly.

### TECHNICAL FIELD

The embodiments presented relate to fault diagnosis in computation systems. Fault diagnosis involves a systematic approach to detecting faults in the operation of hardware components (e.g. processors, memory, storage), or software components (e.g. operating systems, applications).

### BACKGROUND

Analyzing fault diagnosis in computation systems is challenging due to the complexity and scale of modern systems. Managing the vast of mount of data generated by logs, error reports and performance metrics, identifying relevant data points, and isolating the root cause of a fault from this mass information can be tedious and error prone. Additionally, hardware and software components can be interdependent, making it difficult to pinpoint the origin of the fault. Diagnosing causes and presenting solutions involves a thorough understanding of the way computer components interact that may go beyond the expertise of a single entity.

### SUMMARY

According to some embodiments, a method including: receiving, at a large language model (LLM), diagnostic test case results indicating a fault in a computing system; generating, using the diagnostic test case results, an analysis report identifying at least one section of the computing system contributing to the fault; and generating, at the LLM, a solution recommendation to remedy the fault by modifying at least one section of the computing system, using the analysis report.

According to some embodiments, a system including: one or more processors; and one or more memories configured to store an application, which, when executed by a combination of the one or more processors, causes the combination of the one or more processors to perform an operation, the operation including: receiving, at a large language model (LLM), diagnostic test case results indicating a fault in a computing system; generating, using the diagnostic test case results, an analysis report identifying at least one section of the computing system contributing to the fault; and generating, at the LLM, a solution recommendation to remedy the fault by modifying at least one section of the computing system, using the analysis report.

According to some embodiments, a computer-readable storage medium having computer-readable program code embodied therewith, the computer-readable program code executable by one or more computer processors to: receive, at a large language model (LLM), diagnostic test case results indicating a fault in a computing system; generate, using the diagnostic test case results, an analysis report identifying at least one section of the computing system contributing to the fault; and generate, at the LLM, a solution recommendation to remedy the fault by modifying at least one section of the computing system, using the analysis report.

### BRIEF DESCRIPTION OF DRAWINGS

FIG. 1 illustrates a diagnostics analysis system, according to some embodiments.

FIG. 2 illustrates a flow diagram of a diagnostics analysis system, according to some embodiments.

FIG. 3 a data processor, according to some embodiments.

FIG. 4 illustrates a flow diagram of a diagnostics analysis system, according to some embodiments.

FIG. 5 illustrates an example user interface, according to some embodiments.

### DETAILED DESCRIPTION

Embodiments herein relate to analyzing diagnostics data. As mentioned, analyzing faults in computing systems is a tedious, error prone process. Embodiments herein relate to streamlining the analysis process using a data processor and an LLM. The LLM receives test case results from a diagnostics software tool indicating a fault in the hardware or software of a computing system. The LLM uses data from databases containing historical system data as well as debugging data to identify the issue and provide the most probable cause of the issue. The LLM can analyze the data presented, and determine a ranking of the most probable cause to least probable cause of the detected fault. The LLM can provide this information to the user, as well as potential solution recommendations. The fault analyzer system can validate the solution recommendation from the LLM and update the LLM's parameters accordingly.

This diagnostics fault analyzation system improves workflow, as data is processed from multiple sources and provided to an LLM. The LLM can analyze the data and generate responses. The LLM's analytical capabilities can comprehend the interconnectedness of computer parts. Furthermore, the LLM's computing power improves efficiency in analyzing diagnostics, providing more accurate results as the parameters of the LLM can be regularly updated.

Accelerating the process of identifying a resolution for reported failures is one of the challenges addressed in embodiments herein. In the event of diagnostic failures during production, swift debugging solutions (provided by embodiments herein), are technical improvements. Embodiments herein facilitate promptly determining whether the issue originates from software, which can be resolved through software modifications, whether there is a problem hardware defect, which can be addressed using a workaround, or whether the problem hardware defect, and fusing, harvesting or configuration changes, leading to improved yield ratio.

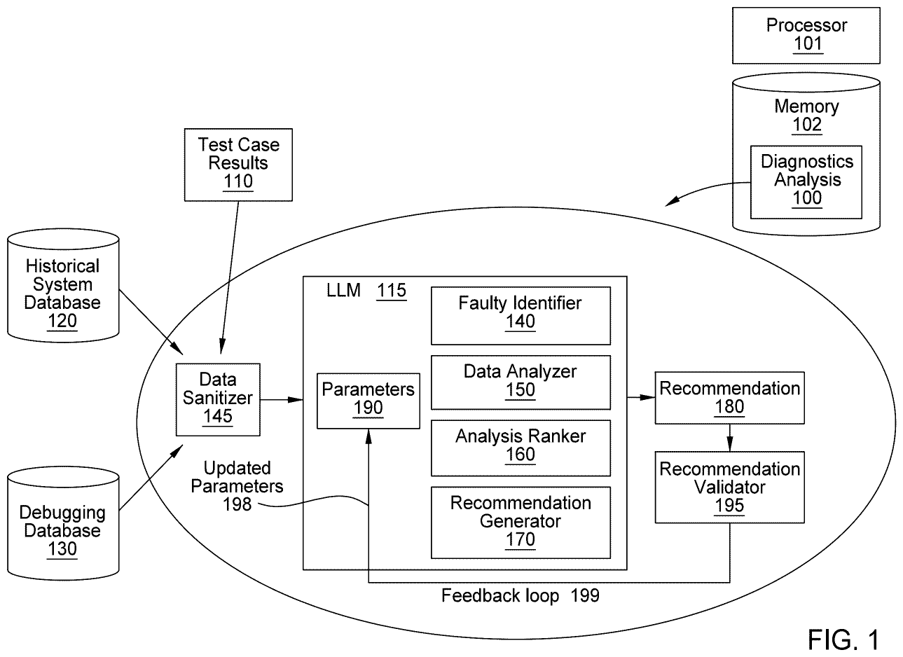

FIG. 1 illustrates a diagnostics analysis system 100 which can be implemented on a computing system with a processor 101, and a memory 102. The processor 101 generally retrieves and executes programming instructions stored in the memory 102. The processor 101 is representative of a single central processing unit (CPU), multiple CPUs, a single CPU having multiple processing cores, graphics processing units (GPUs) having multiple execution paths, specialized AI hardware accelerators (e.g., systems of a chip), and the like.

A CPU can handle tasks that use lower parallelism such as managing the overall workflow, such as loading models, initiating test cases, and delegating tasks to a GPU. A core computation for AI model inference, particularly for LLM models and analysis of test result and data base (first/second data base), would primarily run on the GPU. This allows for efficient parallelized computations, which are instrumental in effective AI processing.

The memory 102 generally includes program code for performing various functions related to use of the diagnosis analysis system 100. The program code is generally described as various functional “applications” or “modules” within the memory 102, although alternate implementations may have different functions and/or combinations of functions. Within the memory 102, the system 100 facilitates constraining values of the quantized neural network, improving efficiency and accuracy of quantized neural networks which is discussed in further detail below.

The diagnostics analysis system 100 receives sanitized test case results 110, data from a historical system database 120, and data from a debugging database 130. In one embodiment, the LLM 115 is a retrieval augmented generation (RAG) system, where the LLM 115 may not be directly trained on the historical system data, or the debugging system data.

The test case results 110 indicate results from a diagnostics system deployed on a computing system. The test case results 110 indicate a fault in a computing system that a separate diagnostics tool may have identified. A computer system can include but is not limited to a validating product and design, a screening parts in production line, or a screening board production in customer production line. The test case results 110 may indicate a fault in a computing system using a diagnostics process designed to verify the computing system's behavior against expected outcomes. When diagnostics software is deployed on a separate system, it can run a series of predefined test cases to validate certain functionalities of the system under test. The results of the test cases can reveal whether the system behaves as expected (passing the test) or if there is a deviation from expected performance, indicating a failure (failing the test). A failure can occur when the actual output of the test case does not match the predicted result, pointing to potential faults such as software bugs, hardware malfunctions, or misconfigurations.

The data from the historical system database 120 includes offline system data. The historical system data/offline data from the historical system database 120 can include information collected and stored from the computing system's (the computing system the test case results are from) past activities, operations, and performance metrics. This collection of data may not be actively used or processed in real time. Additionally, data from the historical system database 120 can include logs, which capture detailed records of events that occurred within the system, performance metrics (e.g. CPU utilization, memory usage, network throughput, etc.), transaction records, past system errors, configuration changes, security related activities, among other things. This data allows the LLM 115 to gain insights on how the system has behaved over time, allowing patterns, recurring issues, or system inefficiencies to be analyzed.

Data from the historical system database 120 can also include domain expert instructions. Domain expert instructions can include guidelines, training data, etc. provided by entities with expertise in a particular field. Domain expert instructions, such as debugging sequence and instruction and design knowledge, can include information used to guide the development, operation or optimization of the system and the processes of the system. Furthermore, domain expert instructions can include information used to guide the development, debugging instruction, detail operation of each functions or IP, steps and sequence of validation.

This data can take various forms, such as labeled datasets, rules, etc. For example, for a system deployed in a healthcare setting, a medical professional may provide labeled medical images or patient case studies that guide AI systems in diagnosing diseases. Domain expert instruction data helps address gaps in general knowledge that could hinder the effectiveness of automated systems. Domain expert instruction data connects real-world conditions to technical functionality.

However, the LLM 115 relying solely on data from the historical system database 120 may cause the LLM to overlook immediate system problems. Hence, data from the debugging database 130 is also received and analyzed by the LLM 115.

Data from the debugging database 130 may be live-system data, or real-time information of the running system the test case results 110 came from. This can include data gathered as the system was actively executing, allowing the behavior of the system to be monitored, and identify issues as they happen. Live-system debugging data can include logs, memory usage, CPU activity, network communication, among other things. This dynamic, real-time view of the system helps the LLM 115 identify issues that may not be apparent from the historical system database 120 data. For example, live-system debugging data can be useful for identifying issues that only occur under certain conditions, such as high traffic loads or certain user interactions. Live debugging data can capture the system's current state, making it easier to address bugs that are dependent on the live system's environment.

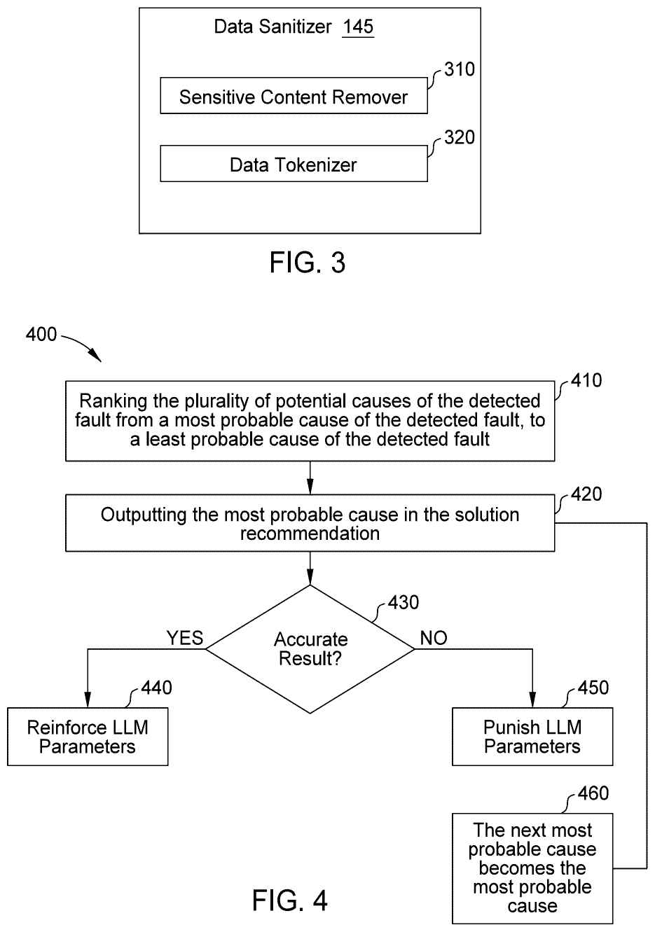

The data sanitizer 145 removes sensitive data from the test case results 110, data from the historical system database 120, and data from the debugging database 130. Sensitive data removed by the data sanitizer 145 can include information that can pose a privacy or security risk if exposed, such as personal identifiable information, financial records, health data, certain design architectural designs, technology, algorithms, setting/configurations, or confidential business information that the LLM 115 should not be exposed to. The historical system database 120 may store data such as user transaction histories, employee records, or system logs, which could contain sensitive information about individuals or organizations. The data sanitizer 145 recognizes this and prevents such data from being shared with the LLM 115. The data sanitizer 145 may prevent such sensitive information from reaching the LLM 115 through various techniques. For example, the data sanitizer may redact the information, or employ methods such as encryption, among other things, to block the sensitive information contained in the databases or test case results 110 from reaching the LLM 115. This is described in more detail in FIG. 3.

The data sanitizer 145 offers improvements in the functioning of the LLM 115, as the LLM 115 will not only have less data to analyze, but more relevant information to analyze, making a stronger likelihood of providing a correct recommendation 180.

The LLM 115 receives the sanitized data and performs a series of analysis before outputting a recommendation 180. The fault analyzer 140 of the LLM 115 determines the fault in the system the test case results 110 are referring to. The fault identifier 140 can use the information from the historical system database 120, the debugging database, and the test case results 110 to pinpoint the fault in the computing system by analyzing patterns, extracting relevant data, and identifying anomalies or inconsistencies. The fault identifier 140 of the LLM 115 can query historical logs, performance metrics, and system configurations from the historical system database 120 and the debugging database 130 to identify trends that correlate with the system failure or performance degradation. For example, if the fault identifier 140 of the LLM 115 compares the expected and actual outputs from the test case results 110 indicating a system failure, and then recognizes a pattern of high CPU usage from the debugging database inconsistent with normal patterns of CPU usage from the historical system debase 120, the fault identifier 140 may pinpoint an issue within the CPU. By examining multiple test case results 110 along with data from the two databases, the fault identifier 140 can pinpoint the conditions or inputs that lead to the system failure identified in the diagnostic test case results 110.

With the fault identifier 140 having identified the potential issue, the data analyzer 150 of the LLM 115 can predict potential causes of the identified potential issue. Using the information from the test case results 110, the historical system database 120, and the debugging database 130, the LLM 115 can use contextual analysis to hypothesize why the potential identified issue may have arisen. The analysis ranker 160 then ranks the potential causes of the issue identified by the data analyzer 150 from most probable to least probable. The analysis ranker 160 considers all of the data presented, and evaluates factors such as frequency, relevance, contextual fit, alongside the list of probable causes identified by the data analyzer 150 and the fault identified by the fault identifier 140. The analysis ranker 160 analyzes patterns in system logs, test case results 110, and the databases to determine causes of faults that have consistently led to similar issues in the past, or match well-known patterns of system failures. The analysis ranker 160 assess the likelihood of the causes based on contextual information (e.g. software updates, configuration, hardware defects, corner cases, additional changes, etc.) and certain conditions under which the fault occurred. If a cause aligns with recent modifications or matches certain symptoms of the issue, it may be ranked as having a higher likelihood than a different probable cause not as closely aligned with the system's current state.

The recommendation generator 170 generates a recommendation 180 meant to overcome the most probable cause of the identified issue. The recommendation 180 provided by the recommendation generator 170 may include certain actions, code snippets, configuration changes, or steps to resolve the issue identified by the fault identifier 140, among other things. In cases where failures are identified as hardware defects, recommendations can including fusing a workaround. Implementing such recommendations would allow the product to be restored and prevent the company from having to discard the part, ultimately leading to cost savings and improved resource efficiency.

The recommendation 180 may provide information on the issue causing the failure in the diagnostic test results 110.

The recommendation validator 180 may include suggestions for further diagnostic tests or monitoring strategies to verify the problem to validate the proposed solution. According to the results of the recommendation validator 195, updated parameters 198 are sent in a feedback loop 199 to the LLM 115. The updated parameters 198 may be a reinforcement of the parameters 190 of the LLM 115 if the recommendation validator 195 deems the recommendation 180 correct, or a punishment for the parameters 190 if the recommendation validator 195 deems the recommendation 180 incorrect.

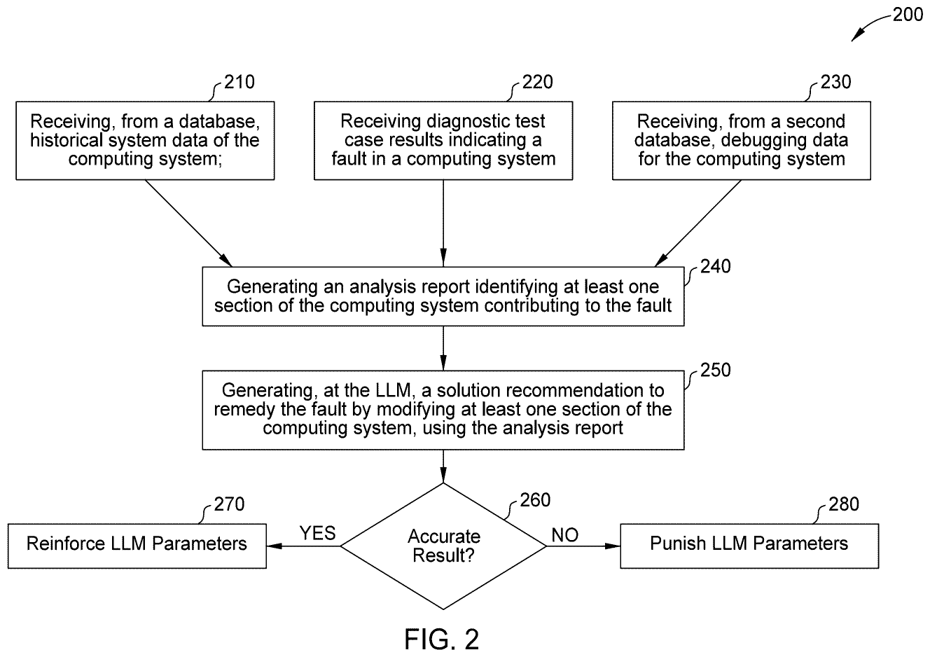

FIG. 2 illustrates a flow diagram 200 of the diagnostics analysis system 100.

At block 210 the diagnosis analysis system 100 receives data from a historical system database. As discussed in FIG. 1, the data from the historical system database is sanitized so that confidential information pertaining to the system the test case results came from are not received by the LLM 115.

At block 220 the LLM receives diagnostic test case results indicating a fault in a computing system. Also as discussed in FIG. 1, diagnostic test case results are from a diagnostics software deployed on a separate computing system. The computing system can be in production for screening. The computer system can be a validating product and design, a screening parts in production line, or a screening board production in customer production line, among other things.

Test case results indicate which software or hardware of the computing system did and did not perform as expected. Test case results indicate a failure, or a fault, in the computing system. Also as discussed in FIG. 1, the test case results received by the LLM are sanitized, with confidential information (e.g. sensitive information regarding the computing system the diagnostics system was deployed on) removed. In some embodiments, the sanitization process includes the LLM providing a report to an external application.

At block 230 the LLM receives data from a debugging database. As discussed in FIG. 1, the debugging database may include live system data from the system the diagnostics system was deployed on. Incorporating data from the debugging system database allows the LLM to generate more accurate responses, as the LLM can perform a more robust analysis on diverse data. Also as discussed in FIG. 1, the data from the debugging database received by the LLM is sanitized, with confidential information removed before reaching the LLM.

At block 240 the LLM generates an analysis report identifying at least one section of the computing system contributing to the fault. As discussed in FIG. 1, the LLM can use the information from the historical system database 120, the debugging database, and the test case results 110 to pinpoint the fault in the computing system by analyzing patterns, extracting relevant data, and identifying anomalies or inconsistencies. The fault identifier 140 of the LLM 115 can query historical logs, performance metrics, and system configurations from the historical system database 120 and the debugging database 130 to identify trends that correlate with the system failure or performance degradation. For example, if the fault identifier 140 of the LLM 115 compares the expected and actual outputs from the test case results 110 indicating a system failure, and then recognizes a pattern of high CPU usage from the debugging database inconsistent with normal patterns of CPU usage from the historical system debase 120, the fault identifier 140 may pinpoint an issue within the CPU. By examining multiple test case results 110 along with data from the two databases, the fault identifier 140 can pinpoint the conditions or inputs that lead to the system failure identified in the diagnostic test case results 110.

At block 250 the LLM generates a solution recommendation to remedy the fault, where the recommendation may be to modify at least one section of the computing system. The LLM may use the analysis report it generates using its data analyzer to aid in generating the solution recommendation. The solution recommendation may include the generated analysis report, the most probable cause of the identified fault, and solutions to remedy the fault, and the use case and impact of a tool by recommendation for revolving the part that is discovered to have hardware defect or has corner case issue. This is discussed in FIG. 1.

At the decision block 260 the recommendation validator of the LLM analyzes the generated recommendation and determines whether or not it is valid. Validating a solution recommendation can involve testing and verifying whether the proposed solution effectively resolves the identified issue without introducing new problems. Developers can administer checks to see if the problems, such as error messages, system crashes, diagnostic test case failures, or performance issues, disappear after applying the solution. They can also ensure that the system continues to function as expected such that no other components are negatively affected. This may be done as a second iteration of diagnostics test case results are compared against the first diagnostic test case results. The second diagnostics test case results can be compared against the first set of diagnostics test case results to determine whether the solution recommendation remedied the fault, where the fault had previously been indicated by the presence of failed test cases. Determining whether the fault has been resolved may be based on the comparison.

At block 270, if the recommendation is deemed accurate, the recommendation validator reinforces the parameters of the LLM. Reinforcing parameters of a model can include fine tuning or updating its internal parameters, or weights, to improve future performance based on the positive feedback.

At block 280, if the recommendation is deemed inaccurate, the recommendation validator punishes the parameters of the LLM. Punishing parameters refers to a process of penalizing certain actions, predictions, or responses during training to discourage incorrect outputs. The LLM can receive negative feedback when it makes an incorrect or ineffective recommendation, improperly describes the issue, among other things. By penalizing these incorrect actions, the model adjusts its internal parameters to reduce the likelihood of repeating the same mistakes in future actions.

FIG. 3 illustrates the data sanitizer 145. As discussed in FIG. 1, the data sanitizer 145 receives the test case results, data from the historical system database, and data from the debugging database.

The sensitive content remover 310 of the data sanitizer 145 removes sensitive or confidential information from the data sets, ensuring privacy and security. As explained in FIG. 1, sensitive or confidential information from the data sources can include personal data, financial records, healthcare information, certain design architectural designs, technology, algorithms, setting/configurations, or other sensitive content that could pose risks if exposed. The sensitive content remover 310 makes the data safe for sharing with the LLM 115, while maintaining its usefulness. Data sanitization can be done using techniques such as anonymization, pseudonymization, encryption, redaction, etc., depending on the data and level of security the data may benefit from.

Anonymization involves stripping personally identifiable information (PII), such as names, social security numbers, or addresses, from the dataset so that individual entities cannot be traced. For example, if the test case results or databases contain customer data, anonymization performed in the sensitive content remover 310 would replace or remove the identifying elements while retaining the non-sensitive information. Pseudonymization, on the other hand, replaces sensitive data with artificial identifiers or tokens (e.g. assigning random numbers in place of a user ID) allowing the data to still be analyzed while hiding the original information.

Data masking is another method that the sensitive content remover 310 may use. Data masking is a method where sensitive content is altered or replaced with “dummy data.” For example, if credit card numbers are considered confidential, the sensitive content remover may replace credit card numbers with realistic, but fake numbers that follow a similar format as the original data. This allows the LLM 115 to be presented with data that mimics real word scenarios without being exposed to actual sensitive content. General redaction is another method the data sanitizer 145 may use, where sensitive data is blocked out.

The sensitive content remover may also use encryption. Encryption involves transforming sensitive data into unreadable code using algorithms that can be deciphered by those with correct decryption keys. The LLM 115 may not have access to the correct decryption keys.

The examples presented above as methods used by the data sanitizer 145 are non-limiting. The sensitive content remover 310 improves computer security, as it helps organize data to comply with privacy laws, prevent data breaches, and ensure sensitive data is handled responsibly without losing its analytical value.

The data tokenizer 320 of the data sanitizer 145 prepares the sanitized data for input into the LLM 115. The data tokenizer 320 creates an input format that the LLM can comprehend.

The data tokenizer 320 converts the sanitized data from at least the test case results 110, historical system database 120, and debugging database 130 into a format the LLM 115 can process.

The tokenizer 320 breaks down data into smaller tokens, which may be individual words, sub words, characters, etc. The smaller tokens can then be mapped to numerical representations that the LLM 115 can analyze and use to make predictions.

The data tokenizer 320 may implement various approaches to tokenization. For example, in scenarios where the data tokenizer 320 implements word-based tokenization, text from the test case results 110, historical system database 120, and debugging database 130 can be split into individual words. In other embodiments, the data tokenizer 320 may use methods such as byte-pair encoding to break words into smaller subunits.

The data tokenizer 320 may map the tokenized text to a numerical value that the LLM 115 may have learned during training. The numerical representation allows the LLM 115 to perform operations such as attention, pattern recognition, and prediction, among other things.

FIG. 4 illustrates a flow diagram 400 of the ranking system.

At block 410 the analysis ranker 160 of the LLM 115 rakes the plurality of potential causes of the issue (where the issue was identified by the fault identifier 140 of the LLM 115) from the most probable cause of the detected fault to the least probable cause of the detected fault.

As discussed in FIG. 1, the LLM 115 receives data from the test case results 110, historical system database 120, and debugging database 130. This data includes system logs, error reports, historical performance metrics, live system data, etc. The LLM 115 can leverage pattern recognition capabilities to compare observed data against data from the historical system database 120 and data from the debugging database 130. The LLM 115 may use its contextual understanding to interpret data in relation to the system's environment to predict possible causes of the identified fault or issue. These processes may occur in the fault analyzer 140 or the data analyzer 150 of the LLM 115. After analyzing data, identifying the fault, and predicting possible causes of the fault, the analysis ranker 160 applies a ranking process where it assigns higher rankings to causes that have stronger correlations with the observed data, or that match fault patterns in the system. The analysis ranker 160 may evaluate factors such as frequency, or how often a particular problem has caused a similar fault in the past, how well a probable cause aligns with the system's current state, recent changes, or certain configurations, among other things. Based on this analysis, the analysis ranker 160 ranks predicted causes of the identified issue from most probable cause to least probable cause.

At block 420 the recommendation generator 170 of the LLM 115 generates a solution recommendation for the identified issue.

The solution recommendation includes identifying the most probable cause of the issue (ranked by the analysis ranker 160), and potential solutions to remedy the fault by modifying at least one section of the computing system. As discussed in FIG. 1, the recommendation generator 170 generates a solution recommendation by using pattern recognition, among other methods, to identify similarities between the current problem, most probable cause, and previously encountered scenarios. The recommendation generator 170 uses the analysis to predict and generate recommendations, such as certain configuration changes, code modifications, workaround of hardware defects, or system adjustments. The response generator's 170 responses can be influenced by its understanding of the identified issue and most probable cause of the identified issue, and its ability to generalize from historical system data and debugging data examples, enabling it to propose solutions that are likely to resolve the issue or guide further diagnostics.

At the decision block 430, the solution recommendation 180 outputted by the recommendation generator 170 is validated. Using techniques discussed in FIGS. 1 and 2, depending on the result, the flow diagram 400 moves to either block 440 or 450.

At block 440, the feedback loop 199 sends updated parameters 198 to the LLM 115, reinforcing the LLM's 115 original parameters 190. This is done if the solution recommendation 180 is valid, as discussed in FIGS. 1 and 2.

At block 450 the feedback loop 199 sends updated parameters 198 to the LLM 115, punishing the LLM's 115 original parameters 190. This is done if the solution recommendation 180 is invalid, as discussed in FIGS. 1 and 2.

At block 460, after it is determined that the recommendation 180 outputted is invalid, and the parameters 190 are updated, the analysis ranker 160 updates its ranked “most probable cause” accordingly. The update involves the next most probable cause becoming the most probable cause. After making this update, the flowchart 400 moves back to block 420, where the process repeats.

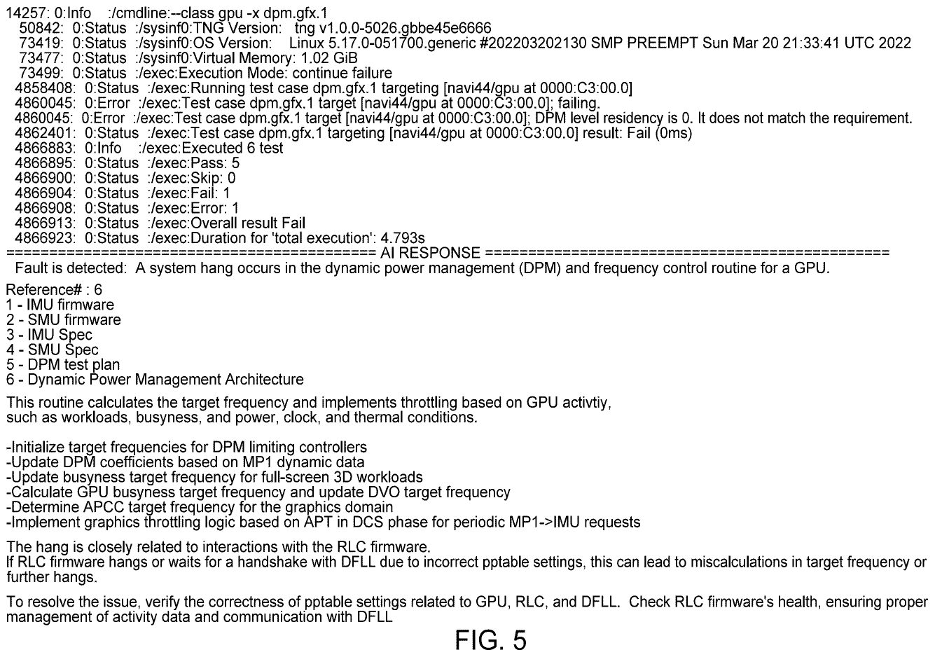

FIG. 5 illustrates an example of the user interface of the diagnostics analysis system 100. The image shows a diagnostic test case indicating a fault in a computing system, and the solution recommendation 180 outputted by the diagnostics analysis system 100. The recommendation 180 provides a thorough failure analysis and suggests solutions for any detected issues, ensuring a more efficient and precise screening, as discussed in FIG. 1.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
receiving, at a large language model (LLM), diagnostic test case results indicating a fault in a computing system;
generating, using the diagnostic test case results, an analysis report identifying at least one section of the computing system contributing to the fault; and
generating, at the LLM, a solution recommendation to remedy the fault by modifying at least one section of the computing system, using the analysis report.

2. The method of claim 1, further comprising:
retrieving, from a first database, historical system data of the computing system, wherein historical system data comprises domain expert instructions; and
retrieving, from a second database, debugging data for the computing system, wherein debugging data comprises live-system data.

3. The method of claim 2, wherein generating, at the LLM, a solution recommendation, is based at least on data from the historical system database, data from the debugging database, and the diagnostic test case results.

4. The method of claim 3, wherein processing the data comprises:
removing sensitive content from the data from the first database, from the data from the second database, and from the diagnostic test case results; and
tokenizing the data into smaller units to create an input format that the LLM can process.

5. The method of claim 2, wherein the analysis report provides a ranking of a plurality of potential causes of the fault by:
determining, at the LLM, the indicated fault in the computing system by querying the first database and the second database to identify trends from the first database and the second database that correlate with the diagnostic test case results;
predicting, at the LLM, a probable cause of the indicated fault based a contextual analysis of the identified trends; and
generating, by the LMM, a likelihood of the cause of the fault using patterns derived from the determined indicated fault and predicted cause of the indicated fault.

6. The method of claim 2, wherein the LLM is part of a RAG system, wherein the LLM is not trained on the historical system data from the first database; and wherein the LLM is not trained on the debugging system data from the second database.

7. The method of claim 1, further comprising:
implementing the solution recommendation in the computing system;
receiving a second set of diagnostic test case results;
comparing the first diagnostic test case results to the second set of diagnostic test case results;
determining whether the fault has been resolved based on the comparison; and
updating parameters of the LLM based on whether or not the fault has been resolved.

8. A system comprising:
one or more processors; and
one or more memories configured to store an application, which, when executed by a combination of the one or more processors, causes the combination of the one or more processors to perform an operation, the operation comprising:
receiving, at a large language model (LLM), diagnostic test case results indicating a fault in a computing system;
generating, using the diagnostic test case results, an analysis report identifying at least one section of the computing system contributing to the fault; and
generating, at the LLM, a solution recommendation to remedy the fault by modifying at least one section of the computing system, using the analysis report.

9. The system of claim 8, further comprising:
retrieving, from a first database, historical system data of the computing system, wherein historical system data comprises domain expert instructions; and
retrieving, from a second database, debugging data for the computing system, wherein debugging data comprises live-system data.

10. The system of claim 9, wherein generating, at the LLM, a solution recommendation, is based at least on data from the historical system database, data from the debugging database, and the diagnostic test case results.

11. The system of claim 10, wherein processing the data comprises:
removing sensitive content from the data from the first database, from the data from the second database, and from the diagnostic test case results; and
tokenizing the data into smaller units to create an input format that the LLM can comprehend.

12. The system of claim 9, wherein the analysis report provides a ranking of a plurality of potential causes of the fault by:
determining, at the LLM, the indicated fault in the computing system by querying the first database and the second database to identify trends from the first database and the second database that correlate with the diagnostic test case results;
predicting, at the LLM, a probable cause of the indicated fault based a contextual analysis of the identified trends; and
generating, by the LMM, a likelihood of the cause of the fault using patterns derived from the determined indicated fault and predicted cause of the indicated fault.

13. The system of claim 9, wherein the LLM is a RAG system, wherein the LLM is not trained on the historical system data from the first database; and wherein the LLM is not trained on the debugging system data from the second database.

14. The system of claim 8, wherein the operation further comprises:
implementing the solution recommendation in the computing system;
receiving a second set of diagnostic test case results;
comparing the first diagnostic test case results to the second set of diagnostic test case results;
determining whether the fault has been resolved based on the comparison; and
updating parameters of the LLM based on whether or not the fault has been resolved.

15. A computer-readable storage medium having computer-readable program code embodied therewith, the computer-readable program code executable by one or more computer processors to:
receive, at a large language model (LLM), diagnostic test case results indicating a fault in a computing system;
generate, using the diagnostic test case results, an analysis report identifying at least one section of the computing system contributing to the fault; and
generate, at the LLM, a solution recommendation to remedy the fault by modifying at least one section of the computing system, using the analysis report.

16. The computer-readable program code of claim 15, further comprising:
retrieving, from a first database, historical system data of the computing system, wherein historical system data comprises domain expert instructions; and
retrieving, from a second database, debugging data for the computing system, wherein debugging data comprises live-system data.

17. The computer-readable program code of claim 16, wherein generating, at the LLM, a solution recommendation, is based at least on data from the historical system database, data from the debugging database, and the diagnostic test case results.

18. The computer-readable program code of claim 17, wherein processing the data comprises:
removing sensitive content from the data from the first database, from the data from the second database, and from the diagnostic test case results; and
tokenizing the data into smaller units to create an input format that the LLM can comprehend.

19. The computer-readable program code of claim 16, wherein the LLM is a RAG system, wherein the LLM is not trained on the historical system data from the first database; and wherein the LLM is not trained on the debugging system data from the second database.

20. The computer-readable program code of claim 15, wherein the operation further comprises:
implementing the solution recommendation in the computing system;
receiving a second set of diagnostic test case results;
comparing the first diagnostic test case results to the second set of diagnostic test case results;
determining whether the fault has been resolved based on the comparison; and
updating parameters of the LLM based on whether or not the fault has been resolved.
